(19) United States
(12) Patent Application Publication
(10) Pub. No.: US 2018/0128299 A1
(43) Pub. Date: May 10, 2018

(54) Vehicle Fixture Component

(71) Applicant: DAIWA KASEI INDUSTRY CO., LTD., Aichi (JP)

(72) Inventors: Katsuya KATABIRA, Aichi (JP); Hideyuki KAWAGUCHI, Aichi (JP)

(21) Appl. No.: 15/718,088

(22) Filed: Sep. 28, 2017

(30) Foreign Application Priority Data
Nov. 4, 2016 (JP) 2016-215822

(51) Int. Cl. F16B 13/08; F16B 2/22

(52) U.S. Cl. CPC F16B 13/0833; B60R 16/0215; F16B 2/22

(57) ABSTRACT

This vehicle fixture component 1 to be fixed in a female screw hole 101H in an attachment member 100 includes a base end portion 2 at the upper side, and an anchor portion 3 at the lower side. The anchor portion 3 includes: a columnar portion 30 extending, from the base end portion 2, downwardly from a first side relative to a penetration portion 2H; an elastic inclined piece 32 having an elastic portion 32B that is thin and that extends in a second side opposite to the first side from the lower side of the columnar portion 30, and an inclined portion 32A that is thick and that extends upwardly from the leading end of the elastic portion 32B and toward a side away from the columnar portion 30; and a head portion 31 opposed to the elastic portion 32B at the lower side thereof.

### RELATED APPLICATIONS

This application claims the priority of Japanese Patent Application No. 2016-215822 filed on Nov. 4, 2016. The disclosure of the prior application is hereby incorporated herein in the entirety by reference.

### BACKGROUND OF THE INVENTION

### Field of the Invention

This invention relates to a vehicle fixture component.

### Description of Related Art

As a vehicle fixture component fixed in a female screw hole of an attachment member provided in a vehicle body, there is a protector that protects a wire harness or the like laid in a vehicle, for example (see Japanese Laid-Open Patent Publication No. 2007-187238). Such a vehicle fixture component is provided with, at a plurality of positions, anchor portions which each include: a columnar portion; and an engagement piece which extends from the left and right sides at the front end of the columnar portion toward the rear end side thereof and which expands outwardly in the radial direction of the columnar portion. The vehicle fixture component is fixed to the attachment member, by the anchor portions at the plurality of positions being respectively pressed into corresponding female screw holes provided in the attachment member. Specifically, each anchor portion is inserted into a female screw hole, while being in an insertion form in which the engagement piece is deflected to be close to the columnar portion. Then, when the deflected state is canceled in the female screw hole, an engagement state is established in which a projecting portion provided to the engagement piece is in the thread groove of the female screw hole, whereby the projecting portion is fixed in the female screw hole.

For such a vehicle fixture component, in order to allow replacement thereof, a structure that allows detachment of the vehicle fixture component has been considered. However, in a case of a conventional vehicle fixture component, since the plurality of anchor portions are inserted and fixed in their corresponding female screw holes in the attachment member, the vehicle fixture component cannot be detached from the attachment member. That is, in order to pull out the anchor portions inserted and fixed in the respective female screw holes, each anchor portion needs to be individually rotated along the thread groove to be pulled out. However, the plurality of anchor portions formed integrally with the vehicle fixture component cannot be individually rotated in the female screw holes. Therefore, at present, there is no other way than forcibly pulling out the vehicle fixture component. However, when the vehicle fixture component is forcibly pulled out, such an anchor portion could be damaged and remain in the thread groove, which requires additional work of removing the remaining part, and the like. This results in reduced work efficiency.

An object of this invention is to provide a vehicle fixture component that can be detached and replaced after being fixed in a female screw hole of an attachment member of a vehicle.

### SUMMARY OF THE INVENTION

A vehicle fixture component that solves the aforementioned problem is a vehicle fixture component to be fixed in a female screw hole in a predetermined attachment member, the vehicle fixture component including:

a base end portion having formed therein a penetration portion penetrating in an up-down direction;

a columnar portion formed at the base end portion so as to project downwardly from a first side, relative to the penetration portion, in a direction orthogonal to a penetrating direction of the penetration portion, the columnar portion configured to be inserted from a lower end side thereof into the female screw hole to be disposed locally at the first side in the female screw hole;

an elastic inclined piece including an elastic portion and an inclined portion,

the elastic portion being formed so as to extend from the lower end side of the columnar portion toward a second side which is opposite to the first side,

the inclined portion being formed so as to extend upwardly from a leading end of the elastic portion, to be inclined so as to be closer to the second side toward the upper side of the inclined portion, and to be operable from above the penetration portion, the inclined portion being thicker than the elastic portion, the inclined portion being provided with a projecting portion on an outer surface thereof at the second side, wherein

when the elastic inclined piece is inserted from the lower end side of the columnar portion into the female screw hole, the elastic inclined piece is capable of taking an insertion form in which the elastic portion is elastically deformed without being plastically deformed, to bring the inclined portion close to the columnar portion, and when the elastic inclined piece is disposed in the female screw hole, the elastic inclined piece is disposed locally to the second side in the female screw hole, and the inclined portion is pressed to the second side in the female screw hole by an elastic restoration force of the elastic portion for separating the inclined portion from the columnar portion, such that the projecting portion enters a thread groove on the second side of the female screw hole, whereby an entirety of the vehicle fixture component is caused to enter a detachment-prevented state relative to the female screw hole; and

a head portion opposed to the elastic portion, at a lower side thereof, with a gap interposed therebetween, wherein

in the detachment-prevented state, the inclined portion is capable of being displaced to the first side through an operation by a user from above the penetration portion, thereby to cause the elastic inclined piece to take the insertion form, and as a result of the insertion form being taken, the entirety of the vehicle fixture component is allowed to be released from the female screw hole.

According to the above configuration, when an anchor portion formed so as to have the columnar portion and the elastic inclined piece is inserted into the female screw hole, the insertion form can be realized in which, with the elastic portion deflected, the inclined portion is brought close to the first side in the radial direction (i.e., the columnar portion side) of the female screw hole. As a result of this insertion form, insertion of the vehicle fixture component into the female screw hole with very little insertion resistance can be facilitated.

In addition, according to the above configuration, simply by causing the elastic inclined piece to be elastically restored after the anchor portion has been inserted into the female screw hole, it is possible to easily bring the entirety of the vehicle fixture component into the detachment-prevented state. That is, according to the above configuration, after the anchor portion has been inserted into the female screw hole, if the state in which the inclined portion is close to the first side in the radial direction (i.e., the columnar portion side) of the female screw hole is canceled, a pressed insertion state is established in which: the inclined portion is pressed against the inner peripheral surface at the second side in the radial direction of the female screw hole by a force for causing restoration from the deflected state of the elastic portion; and the columnar portion is pressed against the inner peripheral surface at the first side in the radial direction of the female screw hole. As a result of the pressing at this time, the projecting portion of the inclined portion is pressed into the thread groove at the second side in the radial direction of the female screw hole. Accordingly, simply by allowing elastic restoration of the elastic inclined piece, the detachment-prevented state can be established in which movement in the up-down direction of the entirety of the vehicle fixture component is restricted.

According to the above configuration, in the detachment-prevented state described above, by a user operating the inclined portion of the elastic inclined piece from above the penetration portion, the detachment-prevented state can be easily canceled. That is, according to the above configuration, since the inclined portion of the elastic inclined piece extends toward the penetration portion so as to allow the user to touch the inclined portion from above the base end portion, the elastic inclined piece can be easily operated into the insertion form described above. If the inclined portion of the elastic inclined piece is formed so as to be long such that the leading end of the inclined portion reaches the inside of the penetration portion or passes through the penetration portion to extend above the penetration portion, the user operation described above is further facilitated.

According to the above configuration, the elastic deformation of the elastic inclined piece occurs in the elastic portion formed in a thin shape so as not to cause plastic deformation thereof, and does not occur at the inclined portion side. Thus, the elastic portion having been elastically restored can be elastically deformed again. Therefore, the anchor portion can be used also after being detached, which allows reuse of the vehicle fixture component. It should be noted that, if the elastic portion is not only formed so as to be thin relative to the inclined portion but also has a flat plate-shaped portion, for example, the elastic portion has a shape that is less likely to cause plastic deformation thereof.

According to the above configuration, in the detachment-prevented state described above, even if the user performs an operation as described above when pulling out the anchor portion from the female screw hole, the projecting portion of the inclined portion and the thread groove in the female screw hole could slightly interfere with each other to cause a force to act that pushes the entirety of the elastic inclined piece downwardly. At this time, elastic deformation that displaces the inclined portion side downwardly is caused in the elastic portion. However, since the head portion is formed so as to be opposed to the elastic portion, at the lower side thereof and in such a manner as to overlap the elastic portion, excessive downward displacement of the elastic portion is prevented by the elastic portion coming into contact with the head portion. Accordingly, plastic deformation caused by excessive upward displacement of the elastic portion can be prevented, and thus, the anchor portion can be used also after being detached, which allows reuse of the vehicle fixture component.

In the above configuration, in the elastic portion and the head portion, respective opposed surfaces thereof may be formed so as to be parallel to each other. Accordingly, excessive upward deformation of the elastic portion can be suppressed to a level of a predetermined displacement or lower.

In the above configuration, at an opposed surface to the inclined portion of the columnar portion, a receded portion may be formed that has a shape receded to the first side relative to a connection position between the columnar portion and the elastic portion such that a distance between the columnar portion and the inclined portion is increased. Accordingly, the inclined portion can be reliably deflected to the first side, and thus, the projecting portion of the inclined portion can be reliably released from the thread groove at the second side in the female screw hole. As a result, the resistance/interference at the time of pulling out the female screw hole can be suppressed. In addition, while the receded portion realizes a long distance between the columnar portion and the inclined portion to provide a sufficient distance by which the inclined portion can be displaced, the receded portion also functions as a restricting portion that restricts excessive displacement by coming into contact with the inclined portion, and thus contributes to prevention of plastic deformation of the elastic portion.

In the above configuration, the projecting portion may be formed locally to a lower side of the inclined portion. The projecting portion formed at the inclined portion may be formed in the entire section in the insertion direction (i.e., the up-down direction) of the female screw hole. However, in such a configuration, insertion resistance and pulling-out resistance received from the female screw hole are increased, which could result in reduced workability. In contrast to this, if the projecting portion is formed only to the lower side (i.e., the elastic portion side) of the inclined portion, such resistances can be decreased. The lower side of the inclined portion is the side where displacement is small in the elastic deformation in which the inclined portion is deflected to the first side. Thus, in a state where the projecting portion of the inclined portion is in the thread groove at the second side in female screw hole, even if the elastic inclined piece is slightly deflected and the inclined portion is displaced, the displacement is small. Thus, the state where the projecting portion is in the thread groove is not easily canceled, and a more reliable detachment-prevented state can be realized.

In the above configuration, the base end portion may have abase end portion-side elastic piece, the base end portion-side elastic piece being provided to the second side relative to the penetration portion, and configured to be elastically deformed by being elastically pushed up by the attachment member in the detachment-prevented state, thereby to urge the entirety of the vehicle fixture component upwardly relative to the attachment member. If the base end portion-side elastic piece does not exist, it is difficult to know how much the anchor portion has been inserted into the female screw hole, and depending on the case, the anchor portion could be stopped before being sufficiently inserted to the depth of the female screw hole, and be in an insufficient engagement state. If the base end portion-side elastic piece exists, when the anchor portion is to be inserted into the female screw hole, reliable insertion of the anchor portion up to the depth of the female screw hole can be confirmed by inserting the anchor portion until the base end portion-side elastic piece is deflected in a reliable manner. Since a gap exists between the projecting portion and the thread groove, rattling could be caused between the female screw hole and the anchor portion. However, the base end portion-side elastic piece being deflected in the detachment-prevented state described above always pushes the entirety of the vehicle fixture component upwardly, and thus, the projecting portion of the inclined portion is always pressed against the upper-side inclined surface of the thread groove in the female screw hole. In particular, the force that pushes the entirety of the vehicle fixture component upwardly acts strongly at a side close to the base end portion-side elastic piece. Thus, as a result the projecting portion of the inclined portion being provided to the base end portion-side elastic piece side, the above-described pressed state is reliably established, whereby rattling can be prevented.

### BRIEF DESCRIPTION OF THE DRAWINGS

FIG. 1 is a perspective view of a vehicle fixture component as one embodiment of this invention;

FIG. 2 is a perspective view of the vehicle fixture component shown in FIG. 1, viewed from a direction different from that in FIG. 1;

FIG. 3 is a front view of the vehicle fixture component shown in FIG. 1;

FIG. 4 is a side view of the vehicle fixture component shown in FIG. 1;

FIG. 5 is a first diagram describing how to fix the vehicle fixture component shown in FIG. 1 to an attachment member, with reference to a V-V cross section shown in FIG. 3;

FIG. 6 is a second diagram consecutive to FIG. 5;

FIG. 7 is a third diagram consecutive to FIG. 6;

FIG. 8 is a diagram describing how to detach the vehicle fixture component shown in FIG. 1 fixed to the attachment member, with reference to the V-V cross section shown in FIG. 3; and

FIG. 9 is a diagram showing elastic deformation that occurs in an elastic inclined piece when the vehicle fixture component shown in FIG. 1 fixed to the attachment member is to be detached, with reference to the V-V cross section shown in FIG. 3.

### DESCRIPTION OF THE PREFERRED EMBODIMENTS

In the following, embodiments of this invention will be described with reference to the examples shown in the drawings.

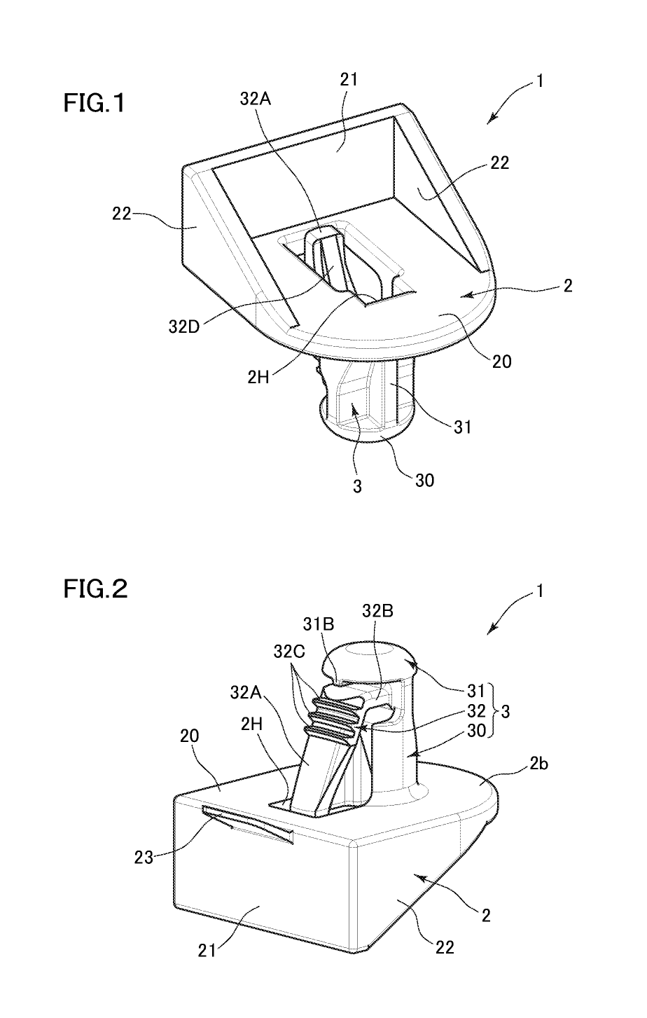

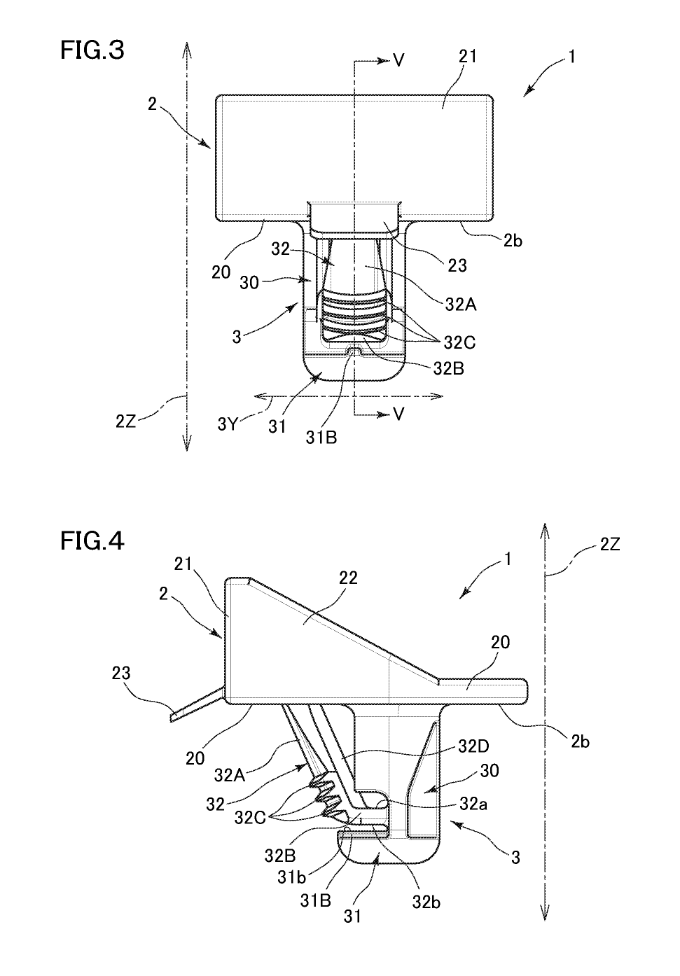

As shown in FIG. 1 to FIG. 4, a vehicle fixture component 1 of this embodiment is a resin injection-molded article integrally provided with: a base end portion 2 having formed therein a penetration portion 2H penetrating in an up-down direction 2Z (see FIG. 3 and FIG. 4); and an anchor portion 3 which is provided to the lower side of the base end portion 2 and which is to be assembled to a predetermined attachment member 100 (see FIG. 5) that is assembled on the vehicle body side. As the resin material, polypropylene, nylon, polyacetal, or the like can be used, for example.

As shown in FIG. 5 to FIG. 9, the attachment member 100 has a fixing portion 101 having a female screw hole 101H formed therein. By the anchor portion 3 being inserted into the female screw hole 101H, the vehicle fixture component 1 is fixed in a detachment-prevented state with respect to the attachment member 100. The attachment member 100 here is a panel member, and the fixing portion 101 is a female screw portion formed so as to protrude downwardly in the plate-like attachment member 100 which is a panel member.

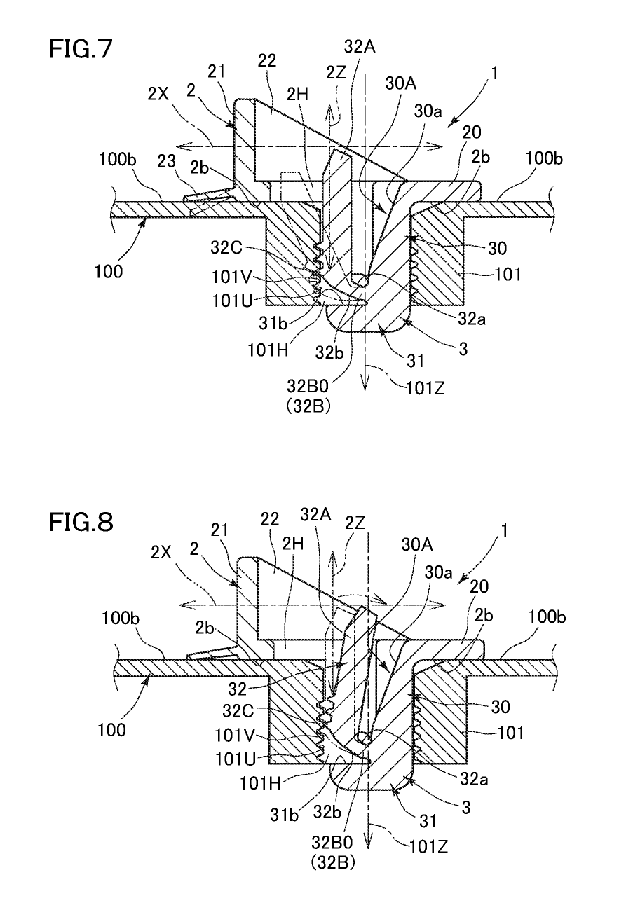

As shown in FIG. 1 to FIG. 4, the base end portion 2 has: a lower face portion 20; wall portions 21, 22; and a base end portion-side elastic piece 23, the lower face portion 20 having a lower surface 2b which comes into surface contact with a main surface 100b (see FIG. 7) being the upper surface of the attachment member 100 when the vehicle fixture component 1 is fixed in the female screw hole 101H of the attachment member 100, the lower face portion 20 having formed therein the penetration portion 2H penetrating the lower surface 2b in the up-down direction 2Z, the wall portions 21, 22 each rising upwardly from the lower face portion 20 without blocking the penetration portion 2H.

Each wall portion 21, 22 functions as an upper functional portion together with the lower face portion 20 with respect to the attachment member 100, and functions as a protective portion that protects a predetermined member (for example, wire harness, etc.) for a vehicle.

The base end portion-side elastic piece 23 projects diagonally downward (see FIG. 4) from a side surface of the base end portion 2 and is formed so as to be long to exceed a plane that is identical to the lower surface 2b of the base end portion 2. The base end portion-side elastic piece 23 here is formed so as to project from the wall portion 21.

As shown in FIG. 1 to FIG. 4, the anchor portion 3 has a columnar portion 30, an elastic inclined piece 32, and a head portion 31, which are integrally formed with one another.

As shown in FIG. 5, the columnar portion 30 is formed at the base end portion 2 so as to project downwardly from a first side (right side in FIG. 5 to FIG. 9), relative to the penetration portion 2H, in a direction 2X orthogonal to the penetrating direction (i.e., the up-down direction 2Z) of the penetration portion 2E. As shown in FIG. 7, the columnar portion 30 is disposed locally at the first side in the female screw hole 101E when the vehicle fixture component 1 is inserted from the lower end side thereof into the female screw hole 101H.

As shown in FIG. 4, the elastic inclined piece 32 integrally has an elastic portion 32B and an inclined portion 32A, the elastic portion 325 being formed so as to extend from the lower end side of the columnar portion 30 toward a second side (i.e., the side opposite to the first side: left side in FIG. 5 to FIG. 9) in the female screw hole 101H (in the direction 2X), the inclined portion 32A being formed so as to extend upwardly from the leading end (i.e., the second side) of the elastic portion 32B, to be inclined so as to be closer to the second side toward the upper side of the inclined portion 32A, and to extend toward the penetration portion 2H of the base end portion 2, such that a leading end of the inclined portion 32A projects above the penetration portion 2H.

As shown in FIG. 5, the elastic portion 325 has a flat plate-shaped portion 32B0 in which an upper surface 32a and a lower surface 32b are each at a plane identical to a plane that is orthogonal to an insertion direction 101Z (here, the up-down direction 2Z) when the vehicle fixture component 1 is inserted from the lower end side thereof into the female screw hole 101H. Since the elastic portion 32B has this flat plate-shaped portion 32B0, when the leading end of the elastic portion 32B is elastically deformed in the up-down direction, the flat plate-shaped portion 32B0 is elastically deformed, and thus, plastic deformation is less likely to occur.

The elastic portion 326 here is connected to the columnar portion 30 and to the inclined portion 32A, in a smoothly continued manner without forming a cornered portion therebetween. The flat plate-shaped portion 32B0 is a portion excluding the connecting portions at the columnar portion 30 side and at the inclined portion 32A side in the elastic portion 32B.

The inclined portion 32A is provided so as to be thicker than the elastic portion 32B, and is formed so as to be more rigid than the elastic portion 32B. Accordingly, active elastic deformation is promoted at the elastic portion 32B side. The inclined portion 32A is provided, on the outer surface thereof at the second side (left side in FIG. 5 to FIG. 9), with a projecting portion 32C which enters a thread groove 101U at the second side in the female screw hole 101H when the vehicle fixture component 1 is inserted from the lower end side thereof into the female screw hole 101H. The projecting portion 32C here is composed of a plurality of thread ridge portions arranged in the insertion direction 101Z so as to be engaged only with a section at the second side of the thread groove 101U.

As shown in FIG. 4, the inclined portion 32A here has, on a surface opposed to the columnar portion 30, a protrusion 32D which projects to the columnar portion 30 side and which extends in the extending direction thereof. Since this protrusion 32D is formed, the inclined portion 32A is made thick and has high rigidity.

The head portion 31 is provided at the lower end of the columnar portion 30, and serves as the insertion head when the vehicle fixture component 1 is inserted from the lower end side thereof into the female screw hole 101H. The head portion 31 is formed so as to extend from the lower end of the columnar portion 30 locally provided at the first side (right side in FIG. 5 to FIG. 9) toward the second side such that the head portion 31 is opposed to the elastic portion 32B, at the lower side thereof, with a gap interposed therebetween. The head portion 31 and the elastic portion 32B are formed such that opposed surfaces 32b and 31b thereof are parallel to each other.

As shown in FIG. 4, the head portion 31 here has, on the upper surface thereof, a protrusion 31B projecting upwardly and extending along the extending direction of the elastic portion 32B, and the opposed surface 31b here is the leading end surface thereof (upper end surface). While the protrusion 31B is connected to the columnar portion 30 at the first side, the protrusion 31B is formed so as to be longer than the elastic portion 32B toward the second side, and is opposed not only to the elastic portion 32B but also to the base end portion side of the inclined portion 32A, in the up-down direction 2Z.

Here, a procedure of inserting and assembling the vehicle fixture component 1 into the female screw hole 101H is described.

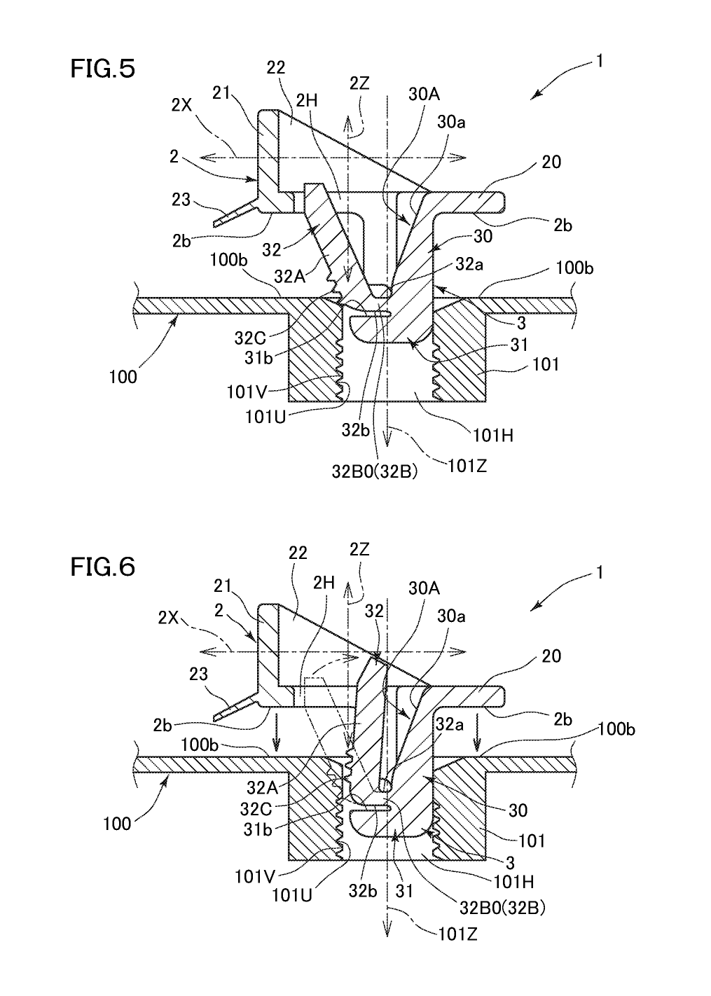

When the vehicle fixture component 1 is to be assembled into the female screw hole 101H, as shown in FIG. 5, the vehicle fixture component 1 is inserted from the lower end side of the columnar portion 30 into the female screw hole 101H. At this time, as shown in FIG. 6, through an operation by a user from above the penetration portion 2H, the inclined portion 32A can be elastically displaced to the first side, thereby to cause the elastic inclined piece 32 to take an insertion form. Through this user operation, the elastic inclined piece 32 having been in an upwardly expanding shape is elastically deformed into an insertion form in which the elastic inclined piece 32 does not expand upwardly. Accordingly, during insertion of the vehicle fixture component 1 into the female screw hole 101H, interference between the projecting portion 32C formed on the outer surface at the second side (left side in FIG. 5 to FIG. 9) of the inclined portion 32A and a thread ridge 101V at the second side of the female screw hole 101H is suppressed, whereby insertion of the vehicle fixture component 1 is facilitated.

In a case where an interfered state between the projecting portion 32C and the thread ridge 101V as shown in FIG. 5 has occurred, if the vehicle fixture component 1 is further strongly pressed into the female screw hole 101H without performing the user operation as described above, the lower-side inclined surface of the projecting portion 32C of the elastic inclined piece 32 presses an opening-side inclined surface formed at the entrance (i.e., upper opening) of the female screw hole 101H, whereby a displacing force toward the columnar portion 30 side acts on the elastic inclined piece 32. Accordingly, elastic deformation of the elastic inclined piece 32 into the above-described insertion form can be caused, which also allows the vehicle fixture component 1 to be inserted to the depth of the female screw hole 101H.

As shown in FIG. 5, the columnar portion 30 has a receded portion 30A formed therein. The receded portion 30A has a shape in which an opposed surface 30a to the inclined portion 32A is receded toward the first side (right side in FIG. 5 to FIG. 9) in the female screw hole 101H, relative to the connection position thereof to the elastic portion 32B such that the distance between the receded portion 30A and the inclined portion 32A is increased. Accordingly, the receded portion 30A can receive the inclined portion 32A coming closer thereto at the time of the above-described insertion form being realized, thus, allows a larger elastic displacement of the inclined portion 32A toward the first side, and thus, greatly contributes to suppression of the interference described above. Meanwhile, the receded portion 30A also functions as a stop portion that comes into contact with the inclined portion 32A of the elastic inclined piece 32 coming closer thereto, and restricts displacement of the inclined portion 32A so as to prevent plastic deformation of the elastic portion 32B.

The columnar portion 30 is not provided with a projecting portion that enters the thread groove 101U of the female screw hole 101H. Thus, at the columnar portion 30 side, no interference with the female screw hole 101H occurs, which facilitates the insertion.

As shown in FIG. 7, when the vehicle fixture component 1 has been disposed in the female screw hole 101H, the columnar portion 30 is disposed locally to the first side (right side in FIG. 5 to FIG. 9) in the female screw hole 101H, and the elastic inclined piece 32 is disposed locally to the second side (left side in FIG. 5 to FIG. 9) in the female screw hole 101H. At this time, the elastic inclined piece 32 has not restored from the above-described insertion form to the original state thereof, and is still in the elastic deformation state. Thus, an elastic restoration force of the elastic portion 32B for separating the inclined portion 32A from the columnar portion 30 is continuously acting on the elastic inclined piece 32. By this elastic restoration force, a pressed insertion state is established in which the columnar portion 30 is always pressed to the first side in the female screw hole 101H, and the inclined portion 32A is always pressed to the second side in the female screw hole 101H. Accordingly, the projecting portion 32C provided on the outer surface at the second side of the inclined portion 32A enters the thread groove 107U at the second side in the female screw hole 101H, and as a result of this entry, a detachment-prevented state is established in which the entirety of the vehicle fixture component 1 is prevented from being detached in the up-down direction relative to the female screw hole 101H.

In this detachment-prevented state, as shown in FIG. 7, the main surface 100b around the female screw hole 101H of the attachment member 100 comes into contact with the lower surface 2b of the base end portion 2. Meanwhile, in this detachment-prevented state, with respect to the base end portion 2, the base end portion-side elastic piece 23 provided to the second side (left side in FIG. 5 to FIG. 9) of the penetration portion 2H is held in an elastic deformation state in which the base end portion-side elastic piece 23 is pushed up as a result of the contact thereof with the main surface 100b, and the base end portion-side elastic piece 23 is urging upwardly the entirety of the vehicle fixture component 1 relative to the attachment member 100. Accordingly, even in a case where a gap exists between the projecting portion 32C of the inclined portion 32A and the thread ridge 101V of the female screw hole 101H and causes rattling, the base end portion-side elastic piece 23 always pushes the entirety of the vehicle fixture component 1 upwardly. As a result, the projecting portion 32C of the inclined portion 32A is held in a state where the lower-side inclined surface of the thread ridge 101V of the female screw hole 101H (i.e., the upper-side inclined surface of the thread groove 101U) is always pressed upwardly, and thus, rattling can be suppressed.

The projecting portion 32C is formed locally to the lower side of the inclined portion 32A. Accordingly, insertion resistance received at the time of the insertion into the female screw hole 101H is decreased. In addition, the lower side of the inclined portion 32A where the projecting portion 32C is formed is the side where displacement is small in the elastic deformation in which the inclined portion 32A is deflected toward the first side to take the insertion form. Thus, even if the elastic inclined piece 32 is slightly deflected to the columnar portion 30 side, the projecting portion 32C is prevented from coming off the thread groove 101U, and thus, a more reliable detachment-prevented state can be realized.

When the vehicle fixture component 1 in the detachment-prevented state described above is to be pulled out from the female screw hole 101H, the inclined portion 32A is displaced toward the first side (right side in FIG. 5 to FIG. 9) in the female screw hole 101H through an operation by a user from above the penetration portion 2H, whereby the elastic inclined piece 32 can be caused to take the insertion form described above, as shown in FIG. 8. As a result of the insertion form described above, the state of the vehicle fixture component 1 is shifted from the detachment-prevented state in which the projecting portion 320 of the inclined portion 32A is in the thread groove 101U in the female screw hole 101H, to a detachment prevention canceled state in which the projecting portion 32C of the inclined portion 32A is released from the thread groove 101U in the female screw hole 101H, whereby the vehicle fixture component 1 can be released upwardly from the female screw hole 101H.

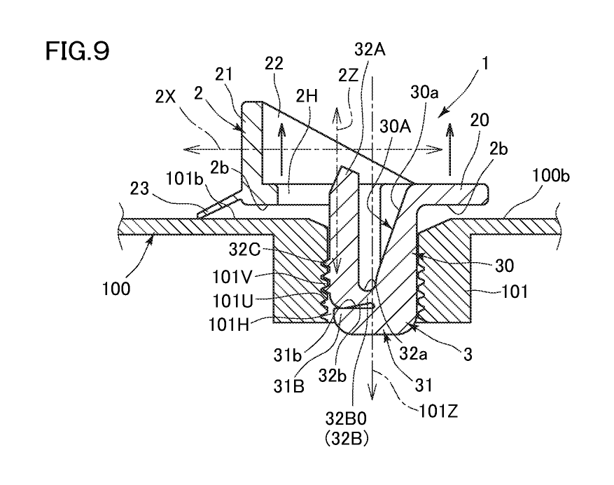

When the vehicle fixture component 1 is to be pulled out upwardly from the female screw hole 101H, the projecting portion 32C of the inclined portion 32A could interfere with the thread ridge 101V of the female screw hole 101H, as shown in FIG. 9. When such interference has occurred, the elastic inclined piece 32 cannot follow the movement of the vehicle fixture component 1 being pulled upwardly, and is left behind. That is, at this time, the elastic inclined piece 32 receives, from the thread ridge 101V of the female screw hole 101H, a force that pushes down the projecting portion 32C of the inclined portion 32A, and the elastic inclined piece 32 enters a state in which the leading end side (i.e., the inclined portion 32A side) of the elastic portion 32B of the elastic inclined piece 32 is elastically deformed downwardly. However, to the lower side of the elastic portion 32B, the head portion 31 is located so as to opposed thereto, and thus, the head portion 31 functions as a stop portion that comes into contact with the elastic portion 32B coming close thereto, and restricts displacement of the leading end side (i.e., the inclined portion 32A side) of the elastic portion 32B so as to prevent plastic deformation of the elastic portion 32B. Here, the protrusion 31B of the head portion 31 functions as the stop portion.

Although an embodiment of this invention has been described above, the embodiment is merely illustrative, this invention is not limited thereto, and various modifications such as addition and omission may be made on the basis of the knowledge of a person skilled in the art without departing from the scope of the claims.

In the following, other embodiments different from the embodiment described above and modifications of those embodiments are described. It should be noted that portions having the same functions as those in the above-described embodiment are denoted by the same reference characters and the detailed description thereof is omitted. In addition, the embodiment described above and the modifications and other embodiments described below may be combined to be implemented as appropriate as long as no technical contradiction arises.

In the embodiment described above, the portion serving as the upper functional portion formed by the base end portion 2 may have a structure that is different from the structure in which the wall portions 21, 22 are provided. The base end portion 2 may not necessarily perform a predetermined function singly by itself, but may perform a function in corporation with other members.

In the embodiment described above, the attachment member 100 is a panel member, but may be another type of member as long as the attachment member 100 has the fixing portion 101 in which the female screw hole 101H is formed at least. In addition, the fixing portion 101 may not have a shape that protrudes from a plate like member as in the embodiment described above.

In the embodiment described above, the base end portion-side elastic piece 23 is formed so as to project from the wall portion 21. However, the base end portion-side elastic piece 23 may have another form as long as the vehicle fixture component 1 is urged upwardly when the vehicle fixture component 1 has entered the detachment-prevented state with respect to the female screw hole 101H.

In the embodiment described above, the elastic portion 32B extends in a direction orthogonal to the extending direction of the columnar portion 30 (see FIG. 5), but may have another form as long as the elastic deformation in which the inclined portion 32A at the leading end side is displaced toward the columnar portion 30 side is realized without causing plastic deformation of the elastic portion 32B.

In the embodiment described above, the inclined portion 32A has a form in which the inclined portion 32A extends upwardly from the leading end side of the elastic portion 32B, passes through the penetration portion 2H of the base end portion 2, and projects above the penetration portion 2H. However, as long as the inclined portion 32A is operable by the user through the penetration portion 2H from above the penetration portion 2H, the inclined portion 32A may have another form. For example, the inclined portion 32A may extend upwardly from the leading end side of the elastic portion 32B, without reaching the inside of the penetration portion 2H of the base end portion 2. Alternatively, the inclined portion 32A may only reach the inside of the penetration portion 2H, without projecting above the penetration portion 2H.

In the embodiment described above, the penetration portion 2H is formed as a penetration hole penetrating in the up-down direction. However, the penetration portion 2H may have another form as long as the penetration portion 2H penetrates in the up-down direction and user operation can be made onto the inclined portion 32A.

### DESCRIPTION OF THE REFERENCE CHARACTERS

1 vehicle fixture component
100 attachment member
100b main surface
101 fixing portion
101H female screw hole
101U thread groove
2 base end portion
2b lower surface
2H penetration portion
23 base end portion-side elastic piece
3 anchor portion
30 columnar portion
31 head portion
32 elastic inclined piece
32A inclined portion
32B elastic portion
32C projecting portion

What is claimed is:

1. A vehicle fixture component to be fixed in a female screw hole in a predetermined attachment member, the vehicle fixture component comprising:
a base end portion having formed therein a penetration portion penetrating in an up-down direction;
a columnar portion formed at the base end portion so as to project downwardly from a first side, relative to the penetration portion, in a direction orthogonal to a penetrating direction of the penetration portion, the columnar portion configured to be inserted from a lower end side thereof into the female screw hole to be disposed locally at the first side in the female screw hole;
an elastic inclined piece comprising an elastic portion and an inclined portion,
the elastic portion being formed so as to extend from the lower end side of the columnar portion toward a second side which is opposite to the first side,
the inclined portion being formed so as to extend upwardly from a leading end of the elastic portion, to be inclined so as to be closer to the second side toward the upper side of the inclined portion, and to be operable from above the penetration portion, the inclined portion being thicker than the elastic portion, the inclined portion being provided with a projecting portion on an outer surface thereof at the second side, wherein
when the elastic inclined piece is inserted from the lower end side of the columnar portion into the female screw hole, the elastic inclined piece is capable of taking an insertion form in which the elastic portion is elastically deformed without being plastically deformed, to bring the inclined portion close to the columnar portion, and when the elastic inclined piece is disposed in the female screw hole, the elastic inclined piece is disposed locally to the second side in the female screw hole, and the inclined portion is pressed to the second side in the female screw hole by an elastic restoration force of the elastic portion for separating the inclined portion from the columnar portion, such that the projecting portion enters a thread groove on the second side of the female screw hole, whereby an entirety of the vehicle fixture component is caused to enter a detachment-prevented state relative to the female screw hole; and
a head portion opposed to the elastic portion, at a lower side thereof, with a gap interposed therebetween, wherein
in the detachment-prevented state, the inclined portion is capable of being displaced to the first side through an operation by a user from above the penetration portion, thereby to cause the elastic inclined piece to take the insertion form, and as a result of the insertion form being taken, the entirety of the vehicle fixture component is allowed to be released from the female screw hole.

2. The vehicle fixture component according to claim 1, wherein
in the elastic portion and the head portion, respective opposed surfaces thereof are formed in parallel to each other.

3. The vehicle fixture component according to claim 1, wherein
an opposed surface to the inclined portion of the columnar portion is formed so as to be receded to the first side relative to a connection position between the columnar portion and the elastic portion such that a distance between the columnar portion and the inclined portion is increased.

4. The vehicle fixture component according to claim 1, wherein
the projecting portion is formed locally to a lower side of the inclined portion.

5. The vehicle fixture component according to claim 1, wherein
the base end portion has a base end portion-side elastic piece, the base end portion-side elastic piece being provided to the second side relative to the penetration portion, and configured to be elastically pushed up by the attachment member in the detachment-prevented state, thereby to urge the entirety of the vehicle fixture component upwardly relative to the attachment member.
